(19) United States
(12) Patent Application Publication
(10) Pub. No.: US 2014/0347197 A1
(43) Pub. Date: Nov. 27, 2014

(54) COCKPIT EMERGENCY DEVICE

(71) Applicant: ZODIAC AEROTECHNICS, PLAISIR CEDEX (FR)

(72) Inventors: Günter Boomgarden, Scharbeutz (DE); Wolfgang Rittner, Ahrensbok (DE); Rüdiger Meckes, Berkenthin (DE)

(21) Appl. No.: 14/362,987

(22) PCT Filed: Dec. 14, 2012
(86) PCT No.: PCT/EP2012/075490

§ 371 Date: Jun. 5, 2014

Related U.S. Application Data
(60) Provisional application No. 61/576,526, filed on Dec. 16, 2011.

(51) Int. Cl. A62B 18/08; B64D 25/00

(52) U.S. Cl. CPC A62B 18/08; B64D 25/00; B64D 2231/025
USPC 340/980

(57) ABSTRACT

The invention relates to a Cockpit emergency device for a crew member of an aircraft incorporating an oxygen mask with a supply housing for supplying oxygen to mouth and/or nose of the crew member and attachment means for attaching said supply housing to the head of the crew member in a position covering mouth and/or nose, respectively, further comprising a see-through-display mounted to said oxygen mask such that said see-through-display is positioned in front of one or both eyes of the crew member and a visual user interface adapted to provide visual information to the crew member via said see-through-display.

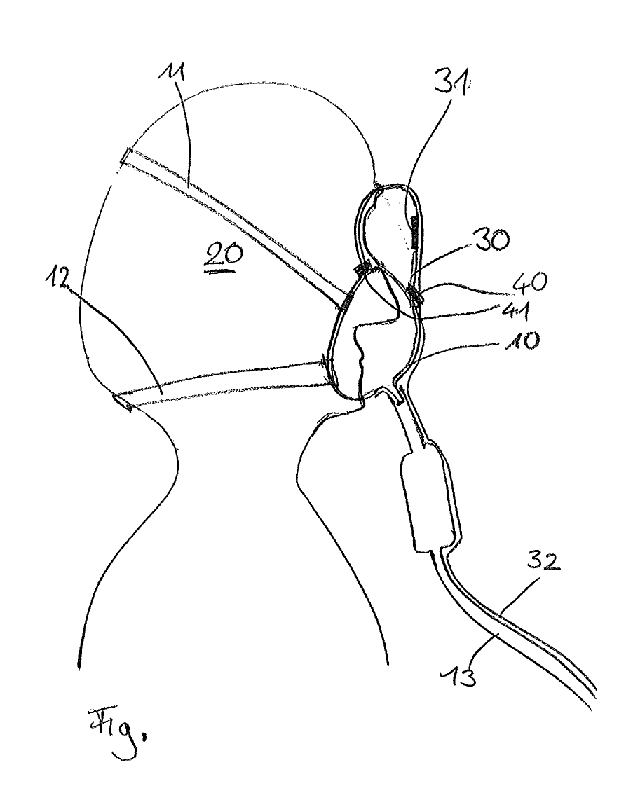

The invention relates to a Cockpit emergency device for a crew member of an aircraft.

Cockpit emergency devices are used to ensure safe operation of an aircraft in an emergency situation and may hereby assist a crew member like a pilot of the aircraft to be able to control and operate switches buttons panels or any other interface devices in the cockpit.

Such emergency devices aim to preserve vital functions of the pilot. For example, it may be required to supply oxygen to the pilot in an emergency decompression situation.

A particular problem associated with such emergency devices is related to the presence of fire, smoke or fog within the cockpit due to misfunction or failure of aircraft components. In such case, it is known to provide breathing air to the pilot to prevent unconsciousness and to thus support vital functions of the pilot or any other crew member by using a cockpit oxygen supply system. However, while such cockpit oxygen supply system may prevent a crew member within the cockpit to become unconscious or experience a drop of concentration and awareness to suffering of breathing air the actual operability of the operating and monitoring instruments of the aircraft within in the cockpit cannot be improved by such devices.

Generally, it is known to allow a pilot to gather information via so called head-up displays. Such head-up displays are known to project information directly into the eye of a patient using a beamer-like apparatus or to allow the pilot to observe a near-field monitor in his field of view. While this allows a pilot to receive information even in case of fire or smoke within the cockpit a major drawback of these system lies in the fact that the pilot is significantly affected in observing his environment and is disturbed in monitoring instruments and any other objects inside the cockpit and outside of the airplane. Further, it was observed that pilots feel bad or sick and have problems to concentrate on the operation of the plane if they are required to rely on such head-up displays for a longer period of time.

It is an object of the invention to improve the operability of the aircraft in such an emergency situation.

This object is achieved by a cockpit emergency device as described beforehand which is improved by incorporating an oxygen mask with a supply housing for supplying oxygen to mouth and/or nose of the crew member and attachment means for attaching said supply housing to the head of the crew member in a position covering mouth and/or nose, respectively, characterized by a see-through-display mounted to said oxygen mask such that said see-through-display is positioned in front of one or both eyes of the crew member and a visual user interface adapted to provide visual information to the crew member via said see-through-display.

The invention addresses the problem that a crew member is often hindered to observe instruments, displays, monitors and the like mounted in the cockpit panel because of smoke or fog in the cockpit. Such presence of smoke or fog often requires substantial efforts of the crew member to get information about the flight situation of the aircraft or system information about components of the aircraft and thus hinders the crew member to concentrate on other activities required to control the aircraft. This draw back is overcome by the invention in that a visual user interface is provided to the crew member which is directly mounted to the oxygen mask used to provide breathing air to the crew member in such an emergency situation. Said visual user interface is to be understood to be an interface which provides visual information to the crew member, namely information like letters, numbers, graphics or the like. This information is provided directly and close to the eyes of the crew member and can thus not significantly be affected by smoke or fog within the cockpit.

As a further characteristic of the visual user interface it is to be noted that the information is provided to the crew member via a see-through-display. Said see-through-display allows the crew member to observe any instruments or steering components within the cockpit or to read manuals, displays, monitor information or to look outside of the aircraft in nearly the same way as if no visual user interface would be present. Thus, the operability of the aircraft is not hindered by the invention in this regard. However, additional information can be safely provided to the pilot by the invention. The see-through-display with the visual user interface may e. g. be realized as a head-up-display projecting information directly onto a transparent screen mounted to the oxygen mask or any other transparent display unit adapted to allow the crew member to look through it and to read at the same time graphical information presented on said screen.

A major advantage of the invention is the fact that the crew member receives breathing air to maintain vital functions and is presented relevant information immediately at the time where the crew member undertakes the step to activate or wear his oxygen mask. Thus, no additional operation or step is required for the crew member to receive the information but instead the component for receiving said information is directly coupled and mounted to the oxygen breathing device, namely the oxygen mask.

According to a first preferred embodiment said see-through-display is adapted to enclose the eyes of the crew member to protect the eyes from smoke within the cockpit to come into contact with the eyes. With this functionality the device according to the invention prevents a further negative consequence of smoke within the cockpit, namely the disturbance of the eye function of the crew member by said smoke. This is achieved by incorporating a smoke sealing function for the eyes into the oxygen mask and at the same time to display visual information as described beforehand via said sealing see-through-display.

Further, the invention maybe improved in that said visual user interface comprises a transparent pattern of light emitting diodes (LED), in particular organic light emitting diodes (OLED) and wherein said transparent pattern is adapted to provide graphical user information to the crew member like numbers, letters, symbols and/or graphics. Such transparent pattern of light emitting diodes maybe a high resolution matrix of LED or OLED which is adapted to provide system or flight information like warning messages, altitude or speed information, graphics like artificial horizon, bearing information, virtual offset and angle information in relation to a runway or the like. It is to be understood that one such transparent pattern maybe present only or that two such transparent pattern maybe present namely one for each eye of the crew member.

Further, the invention maybe improved in that said see-through-display and/or said visual user interface is mounted detachable to said oxygen mask. This improvement allows the crew member to remove the see through display and/or the visual user interface if its function is not required in specific situations and to mount the display/interface hereafter again, if its function is required again.

Further, the invention maybe further improved in that said see-through-display comprises glasses with at least one lens for correcting a defect of vision of the crew member. Very often, pilots or other crew member of an aircraft have individual emergency equipment and in such case a crew member requiring correcting lenses for his eyes may incorporate such lenses into the cockpit emergency device according to the invention.

Thereby it is further preferred that said visual user interface comprises a transparent pattern of light emitting diodes (LED), preferably organic light emitting diodes (OLED) attached to said at least one lens. This integral function further improves the ability of the crew member to operate the aircraft in an emergency situation in that the number of parts required for the ability to perform any control/monitoring functions by said crew member is reduced and the risk that the operability is adversely effected because of missing components is thus reduced.

Further, the invention may comprise switching means for controlling or switching on and off the visual interface. Such switching means may allow the crew member to receive said flight or system information in a first situation and to not receive said information in another situation where it is not required in order to concentrate on other visual information inside the cockpit or outside of the cockpit. Further, said switching means maybe adapted to alter the information presented by the visual user interface, e. g. to switch from an altitude information to a speed information or from an information package presenting both to an information package presenting a virtual information representing the orientation of the aircraft with respect to the horizon or a runway.

Further, the visual user interface may preferably be attached to or integral with the see-through-display. This preferred embodiment provides a specific combination, wherein the see-through-display is directly equipped with means for providing visual information to the crew member, e. g. by directly attaching OLEDs to a transparent screen in front of the eyes of the crew member.

Finally, the invention maybe further improved by a control unit with an interface adapted to receive flight or system information from an aircraft control system and wherein said control unit is adapted to provide such flight or system information to said visual user interface for displaying it to the crew member. Such control unit may be adapted to receive data from a network within in the aircraft and to present flight or system information from said data in a specific display presentation form to the crew member which is particularly adapted for on-screen-presentation in front of the eye of the crew member. Further, said control unit may include switching means for switching between two or more different pieces of information or may allow the crew member to select a number of information elements to be combined in one single presentation.

A further aspect of the invention is a visual user interface adapted to be mounted detachable to an oxygen mask of a cockpit oxygen emergency device. Said visual user interface is understood to correspond to the visual user interface described before hand in connection with the cockpit emergency device and may thus be further improved in the same way as described before hand.

Further, an aspect of the invention is the use of a visual user interface for providing system or flight information of an aircraft to a crew member.

With respect to this use, said visual user interface may comprise a transparent pattern of LED, in particular OLED and said visual user interface, may comprise means for attaching it to the head of the crew member.

Finally, a further aspect of the invention is a method for handling an emergency situation in a cockpit of an aircraft, comprising the steps: Providing oxygen to a crew member in said cockpit via an oxygen mask attached to mouth and/or nose of the crew member, providing system or flight information to said crew member via a visual user interface, in particular via a transparent pattern of LED or OLED, wherein said visual user interface or said transparent pattern of LED/OLED, respectively, is mounted to said oxygen mask.

To this regard, the method according to the invention maybe further improved by comprising the step sealing the eyes of the crew member against smoke in the cockpit with a protective transparent shield being part of or constituted by said visual user interface.

A preferred embodiment of the invention is shown in the figure.

The figure shows an oxygen mask 10 covering mouth and nose of a crew member and being attached to the head 20 of said crew member via straps 11, 12 in such a way that breathing air can be provided to the mouth and nose of the crew member via said oxygen mask. For this purpose, the oxygen mask is connected with an oxygen source via a supply hose 13.

Further, a transparent display unit 30 including a matrix pattern of transparent OLED 31 is attached to said oxygen mask in an upper region. Said OLEDs 31 are arranged in front of the eyes of the crew member if the oxygen mask is positioned for providing oxygen to mouth and nose of the crew member. The OLED are comeded to a control unit via a signal line 32 arranged parallel to the hose 13.

The crew member is able to look through said display unit 30 and said OLEDs 31 and to thus observe and monitor any other devices inside the cockpit or any elements outside the cockpit. At the same time, important system and flight information may be presented to the crew member via said OLED display 31.

The OLED display 30 is mounted to said oxygen mask via a detachable mounting means including form locking clips 41. By this, the OLED display maybe demounted in case that the crew member does not require said direct on screen information in front of his eyes.

1. A cockpit emergency device for a crew member of an aircraft, comprising:
a see-through-display mounted to a fixture for attaching said see-through display to the head of the crew member such that said see-through display is positioned in front of one or both eyes of the crew member,
characterized in that said see-through display comprises a visual user interface adapted to provide visual information to the crew member via said see-through-display wherein said visual user interface comprises a transparent pattern of light emitting diodes (LED), in particular organic light emitting diodes (OLED) and wherein said transparent pattern is adapted to provide graphical user information to the crew member like numbers, letters, symbols and/or graphics.

2. A cockpit emergency device for a crew member of an aircraft, comprising:
an oxygen mask with a supply housing for supplying oxygen to mouth and/or nose of the crew member and attachment means for attaching said supply housing to the head of the crewmember in a position covering mouth and/or nose, respectively, characterized by
a see-through-display mounted to said oxygen mask such that said see-through display is positioned in front of one or both eyes of the crew member and
a visual user interface adapted to provide visual information to the crew member via said see-through-display

3. The cockpit emergency device according to claim 1,
wherein said see-through-display is adapted to enclose the eyes of the crew member to protect the eyes from smoke within the cockpit to come into contact with the eyes.

4. The cockpit emergency device according to claim 2, wherein said visual user interface comprises a transparent pattern of light emitting diodes (LED), in particular organic light emitting diodes (OLED) and wherein said transparent pattern is adapted to provide graphical user information to the crew member like numbers, letters, symbols and/or graphics.

5. The cockpit emergency device according to claim 1,
wherein said see-through-display and/or said visual user interface is mounted detachable to said oxygen mask or fixture, respectively.

6. The cockpit emergency device according to claim 1,
wherein said see-through-display comprises glasses with at least one lens for correcting a defect of vision.

7. The cockpit emergency device according to claim 6,
wherein said visual user interface comprises a transparent pattern of light emitting diodes (LED), preferably organic light emitting diodes (OLED) attached to said at least one lens.

8. The cockpit emergency device according to claim 1,
further comprising switching means for switching on and off the visual user interface.

9. The cockpit emergency device according to claim 1,
wherein the visual user interface is attached to or integral with the see-through-display.

10. The cockpit emergency device according to claim 1,
further comprising a control unit with an interface adapted to receive flight or system information from an aircraft control system and wherein said control unit is adapted to provide such flight or system information to said visual user interface for displaying it to the crew member.

11. The cockpit emergency device according to claim 1,
characterized in that said visual user interface is coupled to a camera arranged for observing an outside area of the plane, in particular in direction of the line of flight of the plane and is adapted to display information received from said camera, in particular the outside environment of the plane in the line of flight.

12. A visual user interface adapted to be mounted detachable to an oxygen mask of a cockpit oxygen emergency device or a helmet or a fixture.

13. The visual user interface according to claim 10, wherein said visual user interface comprises a transparent pattern of light emitting diodes (LED), in particular organic light emitting diodes (OLED) and wherein said transparent pattern is adapted to provide graphical user information to the crew member like numbers, letters, symbols and/or graphics.

14. A use of a visual user interface for providing system or flight information of an aircraft to a crew member.

15. The use according to claim 14, wherein said visual user interface comprises a transparent pattern of LED, in particular OLED and wherein said visual user interface comprises means for attaching it to the head of the crew member.

16. A method for handling an emergency situation in a cockpit of an aircraft, comprising the steps:
Providing oxygen to a crew member in said cockpit via an oxygen mask attached to mouth and/or nose of the crew member,
Providing system or flight information to said crew member via a visual user interface, in particular via a transparent pattern of LED or OLED, wherein said visual user interface or said transparent pattern of LED/OLED, respectively, is mounted to said oxygen mask.

17. The method according to claim 15, further comprising the step:
sealing the eyes of the crew member against smoke in the cockpit with a protective transparent shield being part of or constituted by said visual user interface.
